(19) United States
(12) Patent Application Publication
(10) Pub. No.: US 2023/0403568 A1
(43) Pub. Date: Dec. 14, 2023

(54) METHODS AND APPARATUS TO SLICE NETWORKS FOR WIRELESS SERVICES

(71) Applicant: Intel Corporation, Santa Clara, CA (US)

(72) Inventors: Omid Semiari, Santa Clara, CA (US); Hosein Nikopour, San Jose, CA (US); Shilpa Talwar, Cupertino, CA (US)

(21) Appl. No.: 18/331,799

(22) Filed: Jun. 8, 2023

(51) Int. Cl. H04W 16/22; H04W 16/18; H04W 28/02

(52) U.S. Cl. CPC H04W 16/22; H04W 16/18; H04W 28/0268

(57) ABSTRACT

Systems, apparatus, articles of manufacture, and methods are disclosed to slice networks for wireless services. Example apparatus are to implement an actor-critic neural network to predict a quality of service metric for a network slice based on a long short-term memory representative of one or more prior slicing decisions, compare the quality of service metric with a target service level specification, and update the long short-term memory based on the comparison.

### BACKGROUND

Edge computing provides improved cloud computing services by moving computation and data storage closer to the sources of data. Instead of an edge device or an Internet of Things (IoT) device transmitting data and offloading computations to a central datacenter, an edge network uses base stations (e.g., edge datacenters, edge compute nodes, etc.) deployed closer to endpoint devices that can offer the same functionality of the central datacenter but on a smaller scale. By providing edge nodes closer to edge devices, the network offers much lower latency than if the device were to communicate with the central datacenter. For example, the time it takes to begin a data transfer at the edge node is shorter than it would take to perform the same operations at the central datacenter. Therefore, edge services that rely on cloud storage or computation and also require low latency communication and computations to accomplish tasks can employ edge computing to function properly.

### BRIEF DESCRIPTION OF THE DRAWINGS

FIG. 1 is a block diagram of an example environment in which example network slicing circuitry operates to slice networks for wireless services.

FIG. 2 is a flow diagram of an example network slicing process.

FIG. 3 is a block diagram of an example implementation of the example network slicing circuitry of FIG. 1.

FIG. 4 is a flow diagram of an example framework of an example network slicing process in accordance with teachings disclosed herein.

FIGS. 5-7 are flowcharts representative of example machine readable instructions and/or example operations that may be executed, instantiated, and/or performed by example programmable circuitry to implement the network slicing circuitry of FIG. 3.

FIG. 8 is a block diagram of an example processing platform including programmable circuitry structured to execute, instantiate, and/or perform the example machine readable instructions and/or perform the example operations of FIGS. 5-7 to implement the network slicing circuitry of FIG. 3.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, client devices, retailers, and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Wireless services (e.g., enhanced mobile broadband (eMBB), ultra-reliable low-latency communication (URLLC), massive machine-type communication (mMTC), etc.) have service level specifications (SLSs) that include strict constraints on performance metrics. Such heterogeneous wireless services can support multiple types of edge applications (e.g., cloud gaming devices, wearable devices, sensors, autonomous vehicles, etc.) each having different quality of service (QoS) requirements, such as data rate, latency, reliability, etc. Examples disclosed herein can perform network slicing of a heterogeneous wireless service for an edge application while accounting for the corresponding QoS constraints. As used herein, the term “network slicing” refers to the allocation of available physical resources to different “logical” or “virtual” networks, called slices. In some examples, physical resources include wireless resources (e.g., network bandwidth, transmission power, etc.) and/or compute resources (e.g., memory power, processing power, etc.). As such, examples disclosed herein can allocate a portion of a wireless service network for an edge application while helping to satisfy a service level specification (SLS) of the wireless service.

In some examples, the SLS of a wireless service is associated with a service level agreement (SLA) (e.g., 3^{RD} Generation Partnership Project (3GPP) Technical Specification (TS) 28.530, Version 15.3.0, etc.) and outlines QoS requirements associated with different groups of devices and/or applications, such as smartphones, handhelds (e.g., cloud-gaming consoles), wearables (e.g., cloud-VR headsets), sensors, vehicles, robots, etc. In some examples, the QoS requirements corresponding to the SLS extend beyond first-order statistics and depend on the distribution of performance variables (e.g., packet delay, bandwidth consumption, packet loss, etc.) over many transmissions time intervals (TTIs) (e.g., 10 millisecond (ms) per TTI, etc.), rather than just on a per TTI basis. For example, a reliability metric is the probability that packet delay remains within a certain threshold (specified by the SLS) and may be analyzed to determine whether the QoS requirements are met for a particular service (e.g., autonomous vehicles, etc.). Example methods and apparatus disclosed herein provide a high-level of flexibility for QoS provisioning of different service types (e.g., eMBB, URLLC, mMTC, etc.) associated with unique and complex SLSs. Furthermore, disclosed examples can perform QoS provisioning based on a distribution of TTIs while improving the performance provided to the corresponding edge application by the allocated resources. As such, examples disclosed herein can slice networks with relative efficiency to improve the performance of the wireless service.

Example methods and apparatus disclosed herein perform network slicing for wireless services based on deep recurrent reinforcement learning (RL). In some examples, to perform network slicing, a neural network makes a resource partitioning decision (e.g., allocating bandwidth to slices), and then, assesses the chosen action by measuring the performance (QoS) during an observation window. Then, reward function(s) are used to reinforce the chosen action when the performance satisfies one or more parameters. However, performance measurements during the observation window may be limited to partial information about the true (hidden) state of the network. Thus, in some examples, network resources are allocated using a partially observable Markov Decision Process (POMDP), which accounts for partial state observabilities and non-Markovian rewards.

In some examples, radio access network (RAN) slicing can follow a data-driven (e.g., “model-free”) machine learning approach based on deep neural networks and deep reinforcement learning (DRL) because network slicing is a sequential decision-making problem and fits within the scope of RL. In such examples, a resource allocator is considered as a DRL agent that learns a policy (via trial and error) to map the network state (e.g., traffic demand, queue buffers, etc.) to an action (partitioning resources for allocation to slices). In this context, a target policy is defined as a policy associated with a relatively improved QoS for all slices (i.e., the long-term reward). Examples disclosed herein account for the temporal dependencies in network slicing, statistical constraints on the performance, and/or wireless network dynamics rather than just employing feed-forward neural networks (for the policy or value functions). Additionally or alternatively, examples disclosed herein execute recurrent neural networks to predict observations (e.g., traffic demand) and use those predictions as inputs to the RL agent.

Example methods and apparatus disclosed herein introduce a new RL-based network slicing solution based on deep recurrent actor-critic machine learning to assign resources to network slices while accounting for the heterogenicity of services and network dynamics. Examples disclosed herein employ an example critic (e.g., circuitry implementing a long short-term memory neural network (LSTM) architecture, etc.) to help enable an example RL agent (e.g., network slicing circuitry, etc.) to learn from past experiences (e.g., previous observations-reward-actions) to achieve a relatively efficient and improved policy for network slicing of wireless services having strict SLS and QoS requirements. In some examples, the actor and the critic can be implemented (e.g., trained, stored, etc.) at an edge datacenter with limited memory and compute power. Furthermore, examples disclosed herein can execute the actor and critic at an example near real-time (RT) radio access network (RAN) intelligent controller (RIC) in open radio access network (O-RAN) network architectures.

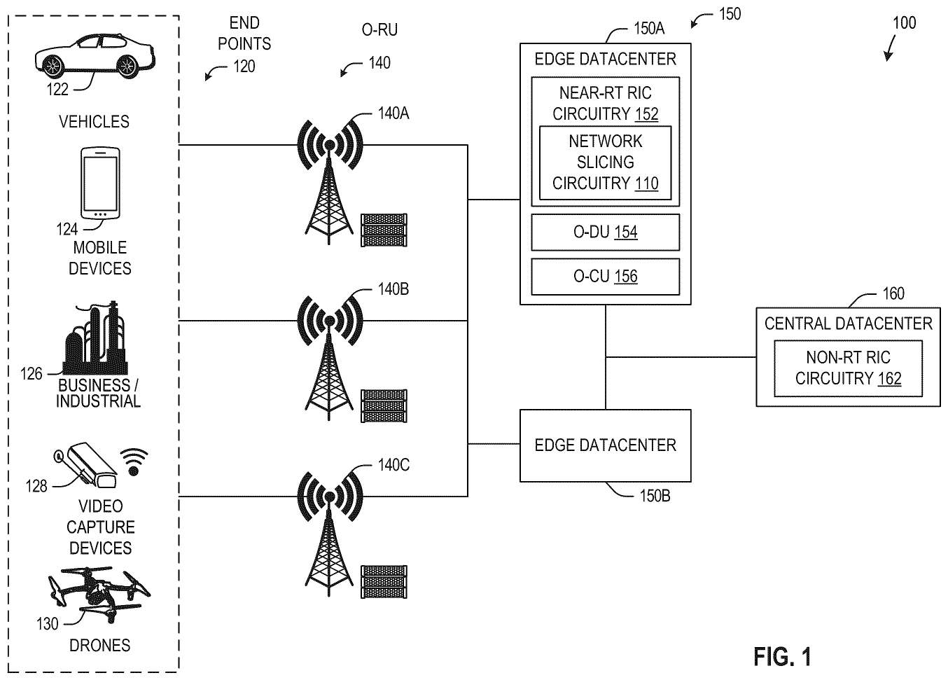

FIG. 1 is a block diagram of an example environment 100 in which example network slicing circuitry 110 operates to allocate resources of a wireless service to network slices based on a deep recurrent actor-critic neural network architecture. The example environment 100 of FIG. 1 includes layers and nodes of processing, storage, and/or connectivity that implement a radio access network. In the illustrated example, the environment 100 corresponds to an O-RAN. However, in some examples, the environment 100 can correspond to another type of RAN, such as a centralized radio access network, a virtualized radio access network, etc.

In the illustrated example, the environment 100 includes example endpoint (consumer and producer) data sources 120 including autonomous vehicles 122, user equipment 124, business and industrial equipment 126, video capture devices 128, and drones 130. Additionally or alternatively, the endpoint data sources 120 can include smart cities, smart building devices, sensors, Internet of Things (IoT) devices, etc. The example environment 100 of FIG. 1 includes example radio units or open radio units (O-RU) 140 (e.g., an example first O-RU 140A, an example second O-RU 140B, an example third O-RU 140C, etc.), example base stations or edge datacenters 150 (e.g., an example first edge datacenter 150A, an example second edge datacenter 150B, etc.), example near-RT RIC circuitry 152, an example open distributed unit (O-DU) 154, an example open central unit (O-CU) 156, an example central datacenter 160, and example non-RT RIC circuitry 162.

The example environment 100 of FIG. 1 includes the example O-RU 140 at the edge of the network to convert radio signals from the endpoint data sources 120 into digital signals. As such, the example O-RU 140 and the example endpoint data sources 120 can be communicatively coupled via wireless connections (e.g., metropolitan-area network (MAN), wide-area network (WAN), etc.). In the illustrated example of FIG. 1, the O-RU 140 include the first O-RU 140A, the second O-RU 140B, and the third O-RU 140C. Additionally or alternatively, the O-RU 140 can include another suitable number of radio units based on a number of services to be supported by the environment 100. In some examples, the O-RU 140 operates the digital front end or front haul of the environment 100. The O-RU 140 can execute instructions and/or perform operations that help ensure network communications adhere to a physical layer of an example network protocol stack, such as the 5G protocol stack.

In the illustrated example of FIG. 1, the O-RU 140 (e.g., radio heads at the “edge” of the network) and the example edge datacenters 150 (e.g., centralized radio controllers) are communicatively coupled via a fronthaul portion of the edge network. Thus, the O-RU 140 can transmit digital signals to the example edge datacenters 150, which are physically farther from the cloud edge. In some examples, the O-RU 140 is connected to the example edge datacenters 150 via wired fiber optics and/or ethernet connections that operate under an evolved Common Public Radio Interface (eCPRI) protocol.

The example environment 100 includes the example edge datacenters 150 to compute workloads for the endpoint data sources 120. In some examples, the edge datacenters 150 include multi-access edge computing (MEC) servers that provide cloud computing capabilities and information technology services at the edge of the network environment 100. The environment 100 includes the edge datacenters 150 to reduce latency and to improve network operation efficiency and service delivery. In the illustrated example of FIG. 1, the edge datacenters 150 include the first edge datacenter 150A and the second edge datacenter 150B. Additionally or alternatively, the edge datacenters 150 can include another number of edge datacenters 150 based on a level of edge computing or information technology (IT) capabilities provided by the environment 100. In some examples, the second edge datacenter 150B has the same architecture and functionality as the first edge datacenter 150A. Thus, examples disclosed in connection with the first edge datacenter 150A can likewise apply to the second edge datacenter 150B and/or other ones of the edge datacenters 150.

The example edge datacenters 150 of FIG. 1 include the example near-RT RIC circuitry 152 to perform data collection and data analytics for network slicing. In some examples, near-RT RIC circuitry 152 is an edge data server that includes the network slicing circuitry 110 in accordance with teachings disclosed herein. The near-RT RIC circuitry 152 helps enable the network slicing circuitry 110 to collect data from the O-RU 140 and perform machine learning tasks associated with resource allocation. In some examples, the near-RT RIC circuitry 152 can enable the network slicing circuitry 110 to perform resource allocation and/or slicing actions within a short time window (e.g., 10 ms to 1 second (s), etc.). In some examples, the near-RT RIC circuitry 152 provides feedback on a slicing policy and/or updates to the policy to the non-RT RIC circuitry 172 as well as O-RAN E2 nodes (e.g., O-CU, O-DU, etc.) via the network slicing circuitry 110.

The example edge datacenters 150 of FIG. 1 include the O-DU 154 to schedule resources and perform QoS provisioning. For example, the O-DU 154 can perform resource scheduling for each slice on a per-TTI level (e.g., every <1 ms interval, etc.). In some examples, the O-DU 154 does not consider performance data over a distribution of TTIs. However, the O-DU 154 can perform resource scheduling based on commands from the network slicing circuitry 110. Therefore, the example O-DU 154 can operate as a medium access controller (MAC) scheduler for resource allocation based on network slicing decisions made by the network slicing circuitry 110. The O-DU 154 can execute instructions and/or perform operations that help ensure network communications adhere to a radio link control (RLC) layer, a medium access control (MAC) layer, and portions of a physical layer of the network protocol stack (e.g., 5G protocol stack).

The example edge datacenters 150 of FIG. 1 include an example O-RAN central unit (O-CU) 156 to control the near-RT RIC circuitry 152 and the O-DU 154. Furthermore, the example O-CU 156 can provide an interface between a hosting O-DU (e.g., the O-DU 154) and higher layers of the edge computing network environment 100, such as the central datacenter 160. That is, the O-CU 156 can transmit communications via an example backhaul portion of the network between the central datacenter 160 and the edge datacenters 150. The O-CU 156 can execute instructions and/or perform operations that help ensure network communications adhere to a radio resource control (RRC) layer and a packet data convergence protocol (PDCP) layer of the network protocol stack.

The example central datacenter 160 of FIG. 1 includes the example non-RT RIC circuitry 162 to enable non-real time (e.g., >1 second, etc.) control of RAN elements (e.g., the O-DU 154, the near-RT RIC circuitry 152, etc.) and allocation of network resources for edge applications. In some examples, the non-RT RIC circuitry 162 can implement the network slicing circuitry 110 allocate resources for different services and/or for offline training of deep recurrent actor-critic neural networks executed by the network slicing circuitry 110.

Examples disclosed herein implement the network slicing circuitry 110 to execute a deep recurrent actor-critic neural network to improve resource assignment/allocation to network slices while accounting for the heterogenicity of wireless services and network dynamics. The example network slicing circuitry 110 can leverage (e.g., execute, train, etc.) a long short-term memory neural network (LSTM) architecture and an RL agent (network slicer) neural network. As such, the network slicing circuitry 110 can train the RL agent using past experiences (e.g., previous observations, rewards, actions, etc.) to achieve an efficient and improved slicing policy for network slicing that satisfies the SLS and QoS requirements associated with the wireless service. In some examples, the network slicing circuitry 110 can be implemented at the first edge datacenter 150A, which has limited memory and compute power. In some examples, the network slicing circuitry 110 can implement an extended application (xApp) at the near RT RIC circuitry 152 in an O-RAN network architecture.

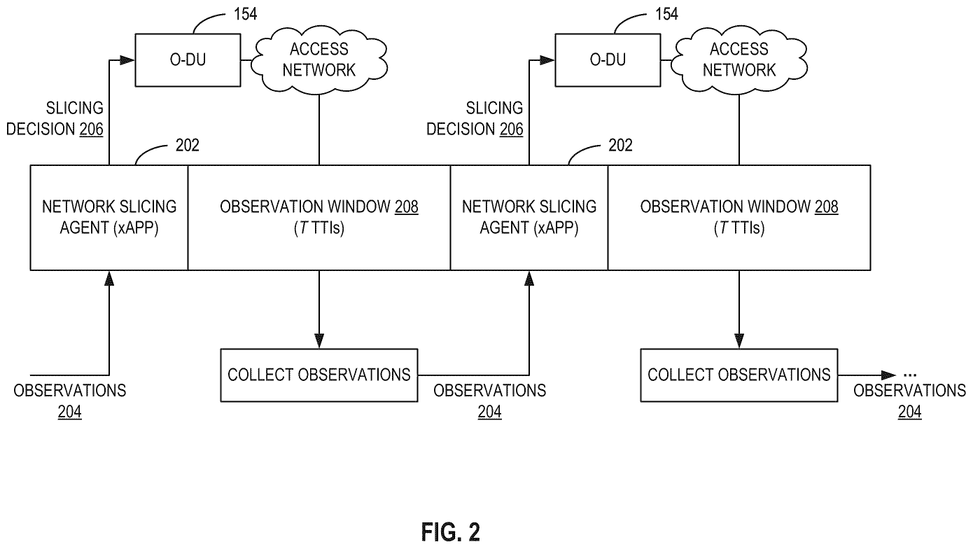

FIG. 2 is a flow diagram of an example network slicing process 200. Examples disclosed herein are described in connection with an example O-RAN that serves U users in a set [symbol] , each with a specified QoS requirement. Based on the users' QoS constraints, K slices within a set [symbol] are instantiated and each user is assigned to at least one slice. Each slice k∈ [symbol] is associated with an SLS that reflects the QoS requirements of the users assigned to slice k. In some examples, the network slicing circuitry 110 executes an example network slicing agent 202 (e.g., xApp, RL agent neural network, etc.) to allocate available resources to K slices based on a set of observations 204 from the RAN. In some examples, at intervals of T number of TTIs, the network slicing circuitry 110 implements the network slicing agent 202 to make or generate a network (e.g., resource) slicing decision 206 based on previous ones of the observations 204 and resource allocations.

The example network slicing circuitry 110 can send the network slicing decision 206 to the O-DU 154, which can operate as a medium access control (MAC) scheduler. As such, the example O-DU 154 can schedule users based on the allocated resources to each slice. The example O-DU 154 (MAC scheduler) interacts with users and manages transmissions over a first observation window 208 (e.g., the next T TTIs), during which the network slicing decision 206 is unchanged. Therefore, in some examples, the network slicing agent 202 is implemented as an xApp at the near-RT RIC circuitry 152 (FIG. 1) to capture the near-RT network dynamics such as time-varying users' activities and traffic demands.

In some examples, the network slicing decision 206 is formulated as an RL problem. In such examples, an MDP is defined as a tuple [symbol] = [symbol] [symbol] , r, p, γ [symbol] where [symbol] is the set of states [symbol] is the set of actions, r: [symbol] × [symbol] → [symbol] is the reward, p(s, a, s′) is the transition probability from state s to state s′ after taking an action a, and γ is the discount factor. Additionally, let λₖ(t)/t denote an average number of total bits (from a set of IP packets) received during t TTIs that are to be processed by the RAN for slice k∈ [symbol] . Moreover, let q_{u,k}(t) represent the queue length (i.e., status) of the radio link control (RLC) at TTI t for a user u∈ [symbol] belonging to a slice k. Therefore, λₖ(t) and q_{u,k}(t) capture, respectively, the traffic load demand per slice and per user. In some examples, the observations 204 correspond to the average number of bits to be processed by the network slice of the cloud network over a time period (λₖ(t)/t) and the queue length of the radio control link for a user of the network slice.

Furthermore, in some examples, there is an assumption that the network slicing decision 206 is made at TTI t₀. In such examples, the new state s∈ [symbol] for the network slicing agent 202 can be defined as a vector that encompasses q_{u,k}(t) and λₖ(t)/t, for all integer TTI indexes t₀<t. The state s is defined over an infinite time horizon to capture the network dynamics caused by sources other than the network slicing agent 202 (e.g., wireless channel fading, interferences, etc.). By contrast, if the state s is defined over a finite timeframe, then for a fixed network slicing action a ∈ [symbol] , the state can still change randomly, which can complicate the policy search. Alternatively, the state s can be defined as the stationary IP traffic arrival

$$( e . g . , {lim}_{t \to ∞} {λ}_{k} ( t ) / t )$$

and queue lengths

$$( e . g . , {lim}_{t \to ∞} {q}_{u , k} ( t ) )$$

after the slicing decision is made 206.

Given either definition provided above for the state s (e.g., infinite timeframe or finite timeframe), the network slicing agent 202 in a real-world scenario observes q_{u,k}(t) and λₖ(t)/t over an example observation window 208 (e.g., a finite time duration) of length T TTIs. Therefore, after the slicing decision 206 is made at time index nT, with n being an integer, the network slicing agent 202 may not effectively estimate the true state of the network slice based on a limited number of previous observations (e.g., [symbol] (n)={q_{u,k}(t), λₖ(t)|(n−1)T≤t<nT}). Thus, network slicing is inherently a POMDP problem where the network slicing agent 202 is to make the slicing decision 206 based on a finite set of observations [symbol] (n). In some examples, the observations 204 are collected from the O-DU 154 over an open interface between two end points (e.g., an E2 interface) based on two schemes: a) periodic or b) event-based. In either example, observations 204 may not be collected every TTI, which further limits the ability of the network slicing agent 202 to estimate the true state.

In some examples, a reward signal r(s, a) is sent to the network slicing agent 202 after taking an action a (e.g., slicing decision 206) at a given (partially observed) state s. In some examples, the network slicing agent 202 receives a relatively high positive reward when a threshold (e.g., the SLSs corresponding to the wireless services) is satisfied for the slices. However, some key QoS metrics for new services (e.g., defined by 3GPP) are dependent on the full statistics of the performance variables, such as the reliability of the distribution of the packet delay. For example, a slice allocated for a URLLC service can have a reliability defined as p(x_{u,k}(a, s)<β) where x_{u,k}(a, s) is the packet delay for a user u in slice k, which is a function of an action a and a state s. Furthermore, β denotes the threshold for the latency specified by the SLS. In another example, a slice allocated for an eMBB service can have a constraint represented as [symbol] [d_{u,k}(a, s)]≥η where [symbol] [d] denotes the expected value of the achieved data rate d_{u,k} (a, s) and q is the threshold data rate specified in the SLS. In such an example, the expected value of the achieved data rate d_{u,k}(a, s) is with respect to signal-to-interference-and-noise ratio (SINR) of all users assigned to a slice k. As such, a few observation samples for the performance metrics (during one instance of observation window 208) may not fully represent the QoS metrics. For example, at an arbitrary TTI where the observations 204 are collected, the channel quality might be high or interference could be less severe, leading to a good instantaneous performance. However, due to the inherent randomness of the wireless channel and interference, the long-term target performance specified by the SLS (e.g., the threshold) may not actually be satisfied. Thus, at least some examples disclosed herein do not solely rely on such QoS metrics for the reward definition. Furthermore, at least some examples disclosed herein not only rely on the current observations 204, but also consider past experiences (e.g., slicing decisions 206 (actions) and observations 204) to estimate the reward (e.g., a quality of service metric, such as a value function including data rate, packet delay, etc.) in a POMDP environment. As such, examples disclosed herein determine the reward based on non-Markovian network slicing decisions to improve computer (e.g., edge datacenter 150A) and network (e.g., O-RAN) performance relative to example methods and apparatus that perform network slicing based on MDP formulations.

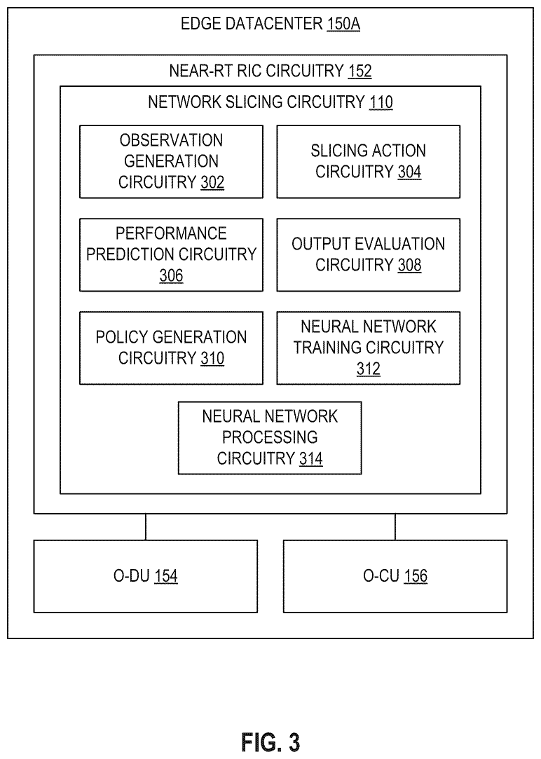

FIG. 3 is a block diagram of an example implementation of the network slicing circuitry 110 of FIG. 1 to assign resources to network slices using deep recurrent actor-critic neural networks while accounting for the heterogenicity of services and network dynamics. The network slicing circuitry 110 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the network slicing circuitry 110 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The example network slicing circuitry 110 of FIG. 3 includes example observation generation circuitry 302, example slicing action circuitry 304, example performance prediction circuitry 306, example output evaluation circuitry 308, example policy generation circuitry 310, example network training circuitry 312, and example neural network processing circuitry 314.

The example network slicing circuitry 110 of FIG. 3 includes the example observation generation circuitry 302 to observe the performance of network slices allocated to wireless services. In some examples, the observation generation circuitry 302 is instantiated by programmable circuitry executing observation generation instructions and/or configured to perform operations such as those represented by the flowchart(s) of FIG.(S). 5 and/or 6. The example observation generation circuitry 302 can access a radio access controller of the edge datacenter 150A to collect network traffic data corresponding to one or more network slices. Furthermore, the observation generation circuitry 302 can determine performance characteristics of the network slices as functions of time based on the network traffic data. For example, the observation generation circuitry 302 can collect transmission data such as a total number of bits obtained for a network slice k over a specified time interval t. Thus, the observation generation circuitry 302 can generate a representation of the network traffic as a function of traffic (e.g., packet arrival) per unit time (λₖ(t)/t). In another example, the example observation generation circuitry 302 can obtain queue lengths corresponding to the number of users u of a particular wireless service and network slice k over the time interval t. Accordingly, the observation generation circuitry 302 can generate a representation of the queue length as a function of time (q_{u,k}(t)). The observations generated by the example observation generation circuitry 302 can be used to determine whether a particular network slice is properly allocated based on the amount of network traffic relative to the QoS requirements of the wireless service.

The example network slicing circuitry 110 of FIG. 3 includes the example slicing action circuitry 304 to execute a first neural network (e.g., a feedforward neural network (FFN)) to decide a slicing action for wireless services. Furthermore, the slicing action circuitry 304 can cause the example O-DU 154 to assign bandwidth and compute resources to user equipment associated with the wireless service. Thus, the slicing action circuitry 304 can cause the O-DU 154 to allocate resources for the network slice based on the slicing action. In some examples, the slicing action circuitry 304 is instantiated by programmable circuitry executing slicing action instructions and/or configured to perform operations such as those represented by the flowchart(s) of FIG.(S). 5 and/or 6.

In some examples, the slicing action circuitry 304 executes the FFN to perform the functions of an actor in a deep recurrent actor-critic model. That is, the slicing action circuitry 304 can execute the FFN based on inputs, such as previous observations, to determine an output in the form of a slicing action. For example, prior to an initial network slicing action, the slicing action circuitry 304 can obtain observations associated with a wireless service from the observation generation circuitry 302 and allocate resources to client devices of users of the wireless service based on the observations. In some examples, the slicing action circuitry 304 provides the slicing action to the O-DU 154 to indicate which resources are to be allocated to a network slice for a wireless service. The O-DU 154 can then act as a MAC scheduler to allocate resources (e.g., bandwidth) to a queue of the users of the network slice based on the slicing action.

The example network slicing circuitry 110 of FIG. 3 includes the example performance prediction circuitry 306 to execute a second neural network (e.g., recurrent neural network (RNN)) as the critic in the actor-critic RL model to predict a value function of the network slice and to determine a cell state of the RNN. In some examples, the second neural network is an LSTM neural network. The value function includes QoS metrics associated with the wireless service and the slicing action. The cell state corresponds to an aggregate of data over time and/or an internal state (e.g., long short-term memory) of the RNN. Unlike the FFN, the RNN repeats similar functions on consecutive inputs of data and uses an embedding of past experiences captured in the cell state to determine a current output. The RNN can use the internal state to process a sequence of inputs that are related to each other. In some examples, the performance prediction circuitry 306 obtains the previous observations, the previous slicing action, and/or the previous value functions as an input vector and outputs a current cell state and a current value function. In some examples, the performance prediction circuitry 306 is instantiated by programmable circuitry executing action analysis instructions and/or configured to perform operations such as those represented by the flowchart(s) of FIG.(S). 5 and/or 6.

The example network slicing circuitry 110 of FIG. 3 includes the example output evaluation circuitry 308 to determine whether the value function output from the performance prediction circuitry 306 satisfies a threshold of the wireless service. In some examples, the threshold corresponds to the SLS and/or QoS requirements of the wireless service. In some examples, the output evaluation circuitry 308 is instantiated by programmable circuitry executing SLS evaluation instructions and/or configured to perform operations such as those represented by the flowchart(s) of FIG.(S). 5 and/or 6. In some examples, the output evaluation circuitry 308 can identify different QoS metrics included in the output value function from the action analysis circuitry. Furthermore, the output evaluation circuitry 308 can predict performance statistics of the network slice based on the output value function. Thus, the example output evaluation circuitry 308 can determine whether the threshold is satisfied based on a comparison between the predicted performance and the SLS associated with the wireless service.

The example network slicing circuitry 110 of FIG. 3 includes the example policy generation circuitry 310 to output a slicing policy for future slicing actions. In some examples, the policy generation circuitry 310 is instantiated by programmable circuitry executing policy generation instructions and/or configured to perform operations such as those represented by the flowchart(s) of FIG.(S). 5 and/or 6. When the output evaluation circuitry 308 determines that the predicted QoS metrics (e.g., the value function) satisfies the threshold (e.g., the SLS), the example policy generation nation circuitry 310 can evaluate the slicing action (e.g., current slicing action) implemented by the slicing action circuitry 304 and output the policy based on the slicing action, the observations, and/or the cell state. The policy can be a mapping from the observations of the network slice to a probability distribution of slicing actions to be taken to improve the QoS of the network slice for the wireless service. Thus, the policy can be used to facilitate future network slicing actions to improve the QoS for wireless services associated with the actions. In some examples, the policy generation circuitry 310 generates and outputs a policy that is applicable to a particular network slice and/or wireless service. In some examples, the policy is applicable to a plurality of network slices and/or wireless services.

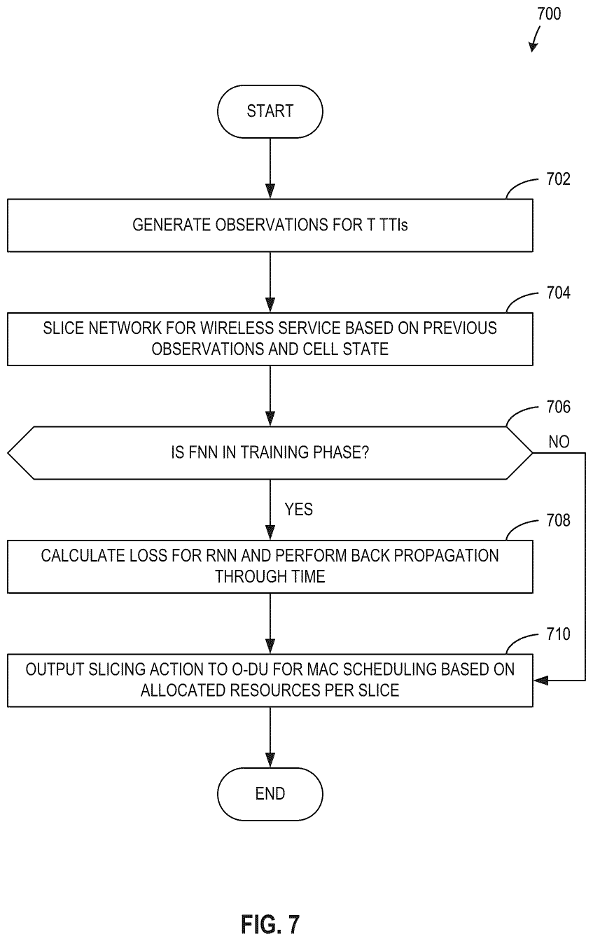

The example network slicing circuitry 110 of FIG. 3 includes the example neural network training circuitry 312 to perform training of the FFN and/or the RNN implemented by the neural network processing circuitry 314. In some examples, the neural network training circuitry 312 is instantiated by programmable circuitry executing neural network training instructions and/or configured to perform operations such as those represented by the flowchart(s) of FIG. 7. In some examples, the neural network training circuitry 312 first trains the RNN (e.g., LSTM) based on a predetermined exploration policy (e.g., epsilon-greedy, etc.). The neural network training circuitry 312 can then use back propagation through time (BPTT) to train the RNN. In some examples, the neural network training circuitry 312 trains the FFN after the RNN is trained. Thus, the neural network training circuitry 312 can deactivate the exploration policy and use BPTT to train the FFN. In some examples, the neural network training circuitry 312 calculates an error at the output (e.g., obtained value) of the fixed (already trained) RNN with the target value, which is determined based on the SLSs of the network slices.

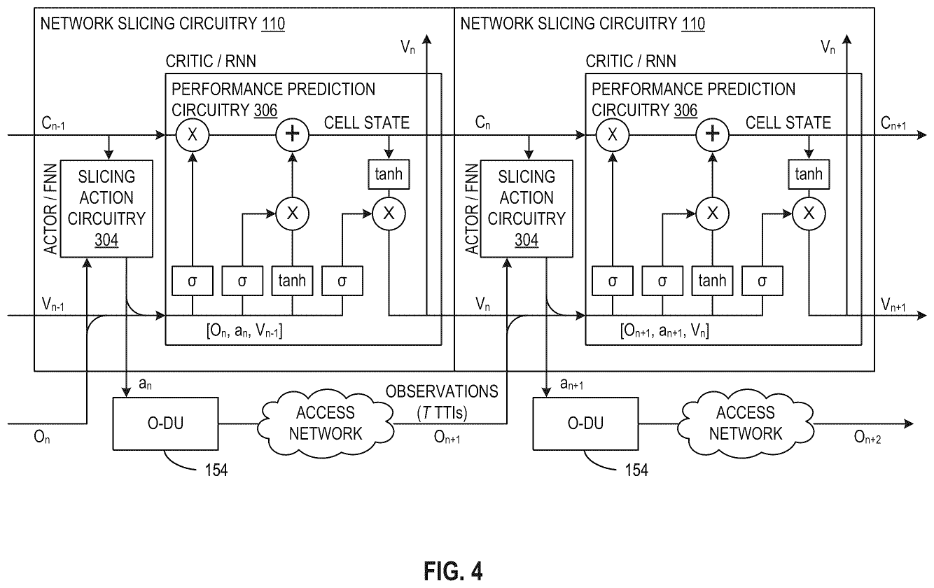

FIG. 4 is a flow diagram of an example framework of an example network slicing process 400 in accordance with teachings disclosed herein. In the illustrated example of FIG. 4, the network slicing circuitry 110 employs an actor-critic model. Furthermore, the example performance prediction circuitry 306 of FIG. 4 can implement an RNN (e.g., a critic neural network represented as an LSTM block in FIG. 4), which enables an FFN (e.g., an actor neural network) implemented by the example slicing action circuitry 304 to learn a value/reward, denoted as V. Additionally, the action analysis circuitry 304 can embed a cell state [symbol] to capture past experiences. The example action analysis circuitry 304 can execute the LSTM to determine the cell state [symbol] based on four inputs: 1) observations [symbol] (n), 2) the action or slicing action aₙ, 3) the previous cell state Cₙ₋₁, and 4) the previous output value Vₙ₋₁. The cell state Cₙ carries an embedding representation for the past experiences (e.g., aggregate of data), thus, allowing the slicing action circuitry 304 to recall relevant information (e.g., past actions, rewards, observations, etc.). Thus, the neural network training circuitry 312 and/or the slicing action circuitry 304 can efficiently train the FFN in a POMDP environment. In the illustrated example of FIG. 4, the slicing action circuitry 304 executes a deep FFN to output an action at based on two inputs: 1) observations [symbol] (n)={q_{u,k}(t), λₖ(t)|(n−1)T≤t<nT} and 2) the previous cell state Cₙ₋₁. Although the example performance prediction circuitry 306 executes an LSTM in FIG. 4, in some examples, the performance prediction circuitry 306 executes another type of RNN, such as a hidden Markov model (HMM), a conditional random field (CRF), a gated recurrent unit (GRU), etc.

The illustrated example of FIG. 4 represents the learning process via the deep recurrent actor-critic, unfolded over a 2T TTI timeframe. That is, after making a slicing decision aₙ at time nT and updating the value Vₙ, the weights of the LSTM and FFN will be updated through backpropagation through time (BPTT), and the process will be repeated every T TTI.

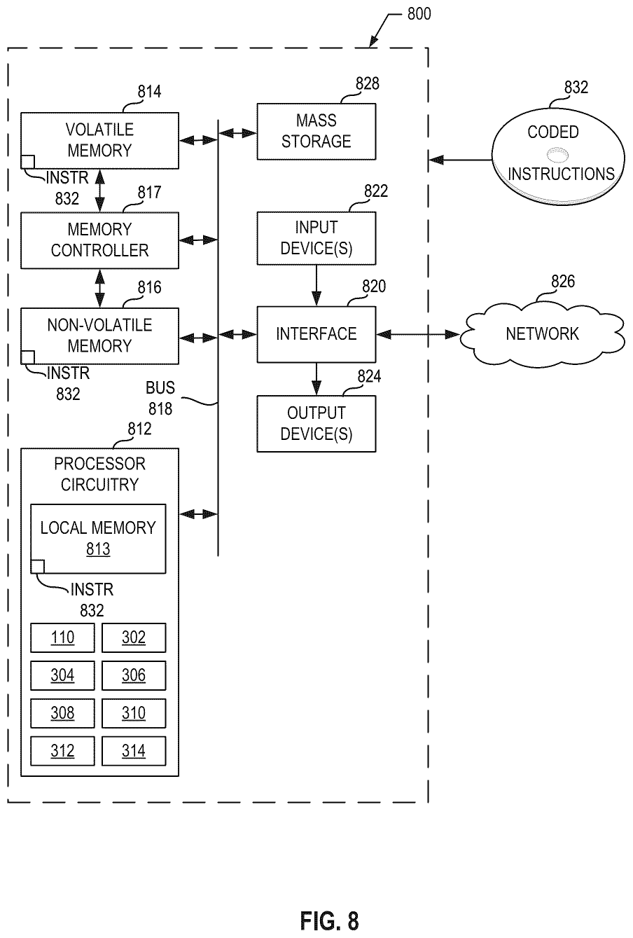

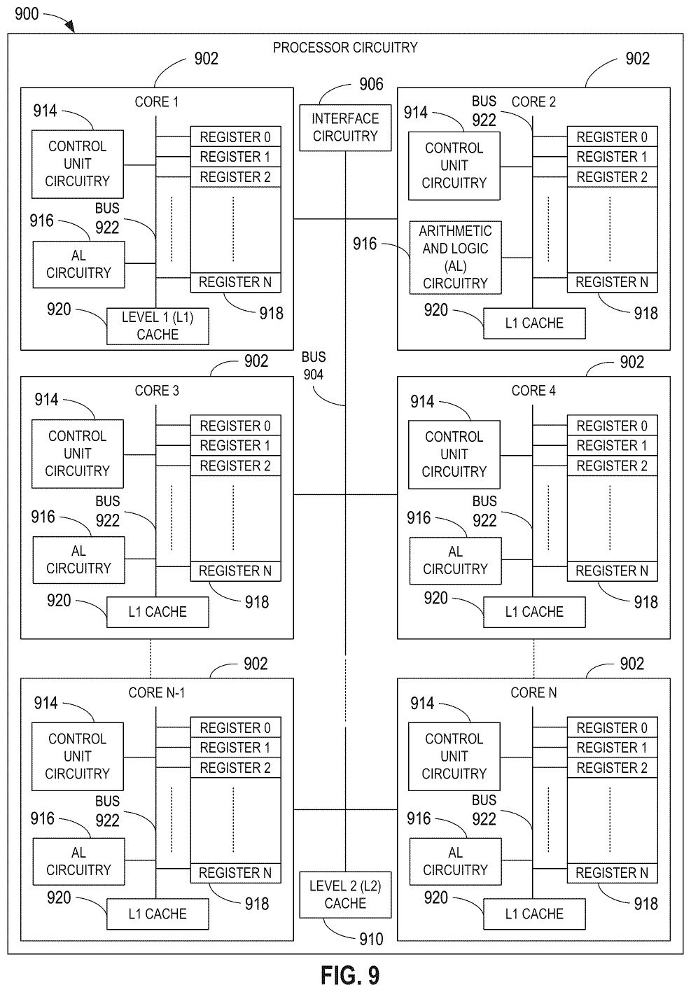

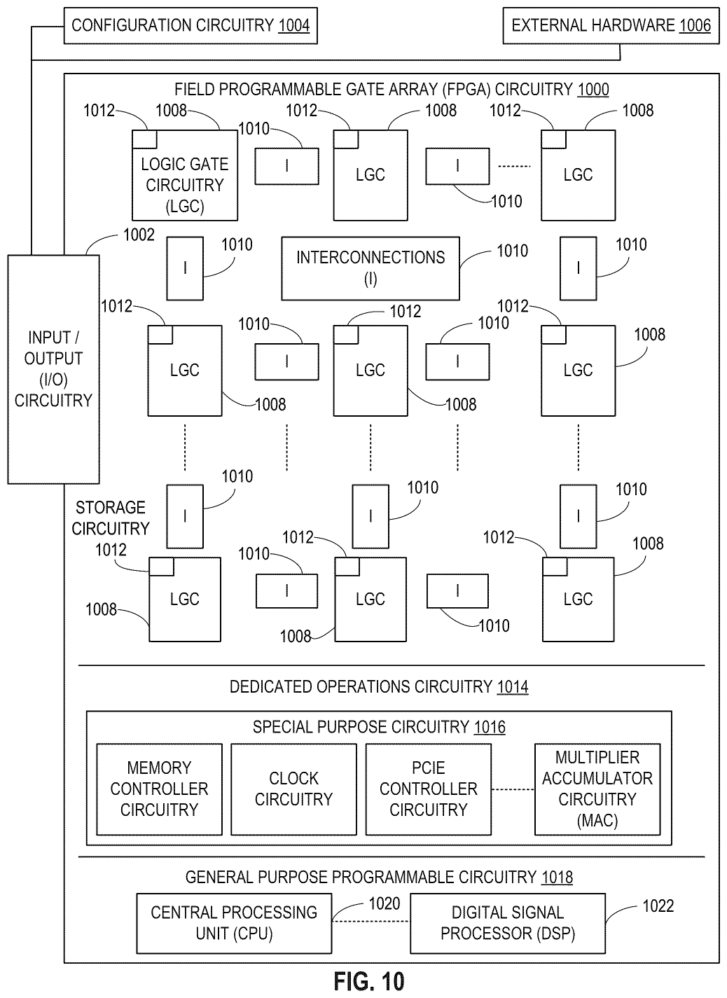

In some examples, the network slicing circuitry 110 includes means for generating observations corresponding to network slices. For example, the means for generating observations may be implemented by the observation generation circuitry 302. In some examples, the observation generation circuitry 302 may be instantiated by programmable circuitry such as the example programmable circuitry 812 of FIG. 8. For instance, the observation generation circuitry 302 may be instantiated by the example microprocessor 900 of FIG. 9 executing machine executable instructions such as those implemented by at least blocks 702 of FIG. 7. In some examples, the observation generation circuitry 302 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the observation generation circuitry 302 may be instantiated by any other combination of hardware, software, and/or firmware. For example, the observation generation circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

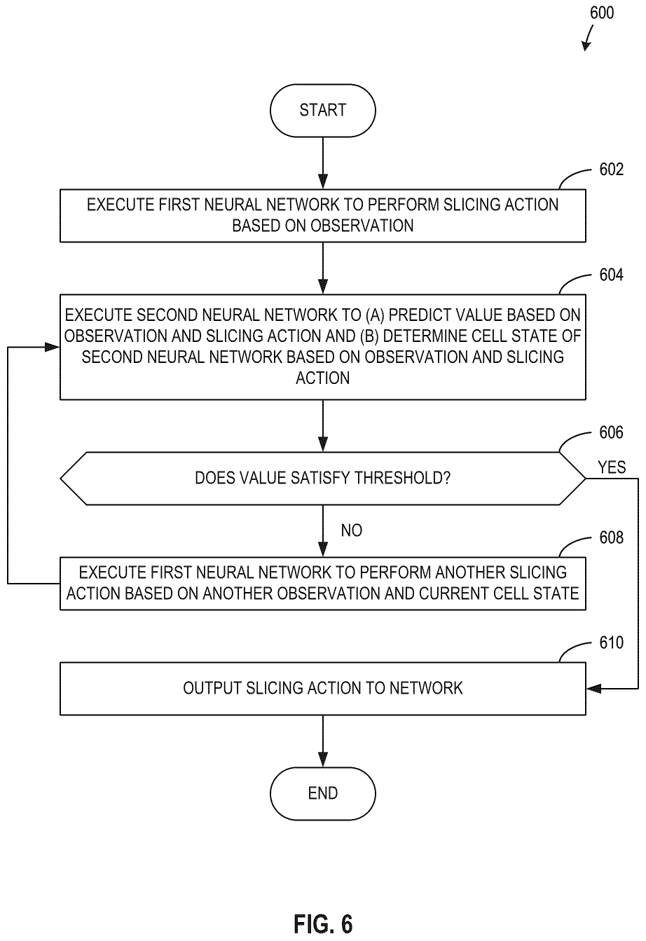

In some examples, the network slicing circuitry 110 includes means for slicing networks for wireless services. For example, the means for slicing networks may be implemented by the slicing action circuitry 304. In some examples, the slicing action circuitry 304 may be instantiated by programmable circuitry such as the example programmable circuitry 812 of FIG. 8. For instance, the slicing action circuitry 304 may be instantiated by the example microprocessor 900 of FIG. 9 executing machine executable instructions such as those implemented by at least blocks 602 and 608 of FIGS. 6 and 704 and 710 of FIG. 7. In some examples, the slicing action circuitry 304 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the slicing action circuitry 304 may be instantiated by any other combination of hardware, software, and/or firmware. For example, the slicing action circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the network slicing circuitry 110 includes means for predicting the performance (e.g., QoS metrics) associated with the slicing action. For example, the means for predicting the performance may be implemented by the performance prediction circuitry 306. In some examples, the performance prediction circuitry 306 may be instantiated by programmable circuitry such as the example programmable circuitry 812 of FIG. 8. For instance, the performance prediction circuitry 306 may be instantiated by the example microprocessor 900 of FIG. 9 executing machine executable instructions such as those implemented by at least blocks 604 of FIG. 6. In some examples, the performance prediction circuitry 306 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the performance prediction circuitry 306 may be instantiated by any other combination of hardware, software, and/or firmware. For example, the performance prediction circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the network slicing circuitry 110 includes means for evaluating the output value function (e.g., predicted performance) from the performance prediction circuitry 306 and associated with the slicing action. For example, the means for evaluating the output value function may be implemented by the output evaluation circuitry 308. In some examples, the output evaluation circuitry 308 may be instantiated by programmable circuitry such as the example programmable circuitry 812 of FIG. 8. For instance, the output evaluation circuitry 308 may be instantiated by the example microprocessor 900 of FIG. 9 executing machine executable instructions such as those implemented by at least blocks 606 of FIG. 6 and 708 of FIG. 7. In some examples, the output evaluation circuitry 308 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the output evaluation circuitry 308 may be instantiated by any other combination of hardware, software, and/or firmware. For example, the output evaluation circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the network slicing circuitry 110 includes means for outputting a slicing policy based on the slicing action when the output value function satisfies the SLS(s) of the wireless service(s). For example, the means for outputting the slicing policy may be implemented by the policy generation circuitry 310. In some examples, the policy generation circuitry 310 may be instantiated by programmable circuitry such as the example programmable circuitry 812 of FIG. 8. For instance, the policy generation circuitry 310 may be instantiated by the example microprocessor 900 of FIG. 9 executing machine executable instructions such as those implemented by at least blocks 610 of FIG. 6. In some examples, the policy generation circuitry 310 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the policy generation circuitry 310 may be instantiated by any other combination of hardware, software, and/or firmware. For example, the policy generation circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the network slicing circuitry 110 includes means for training the actor-critic model (e.g., the FNN and the LSTM) executed by the network slicing circuitry 110 to allocate resources for network slices. For example, the means for training the actor-critic model may be implemented by the neural network training circuitry 312. In some examples, the neural network training circuitry 312 may be instantiated by programmable circuitry such as the example programmable circuitry 812 of FIG. 8. For instance, the neural network training circuitry 312 may be instantiated by the example microprocessor 900 of FIG. 9 executing machine executable instructions such as those implemented by at least blocks 706 of FIG. 7. In some examples, the neural network training circuitry 312 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the neural network training circuitry 312 may be instantiated by any other combination of hardware, software, and/or firmware. For example, the neural network training circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the network slicing circuitry 110 of FIG. 1 is illustrated in FIG. 3, one or more of the elements, processes, and/or devices illustrated in FIG. 3 may be combined, divided, re-arranged, omitted, eliminated, and/or implemented in any other way. Further, the example observation generation circuitry 302, the example slicing action circuitry 304, the example performance prediction circuitry 306, the example output evaluation circuitry 308, the example policy generation circuitry 310, the example neural network training circuitry 312, the example neural network processing circuitry 314, and/or, more generally, the example network slicing circuitry 110 of FIG. 3, may be implemented by hardware alone or by hardware in combination with software and/or firmware. Thus, for example, any of the example observation generation circuitry 302, the example slicing action circuitry 304, the example performance prediction circuitry 306, the example output evaluation circuitry 308, the example policy generation circuitry 310, the example neural network training circuitry 312, the example neural network processing circuitry 314, and/or, more generally, the example network slicing circuitry 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example network slicing circuitry 110 of FIG. 3 may include one or more elements, processes, and/or devices in addition to, or instead of, those illustrated in FIG. 3, and/or may include more than one of any or all of the illustrated elements, processes and devices.

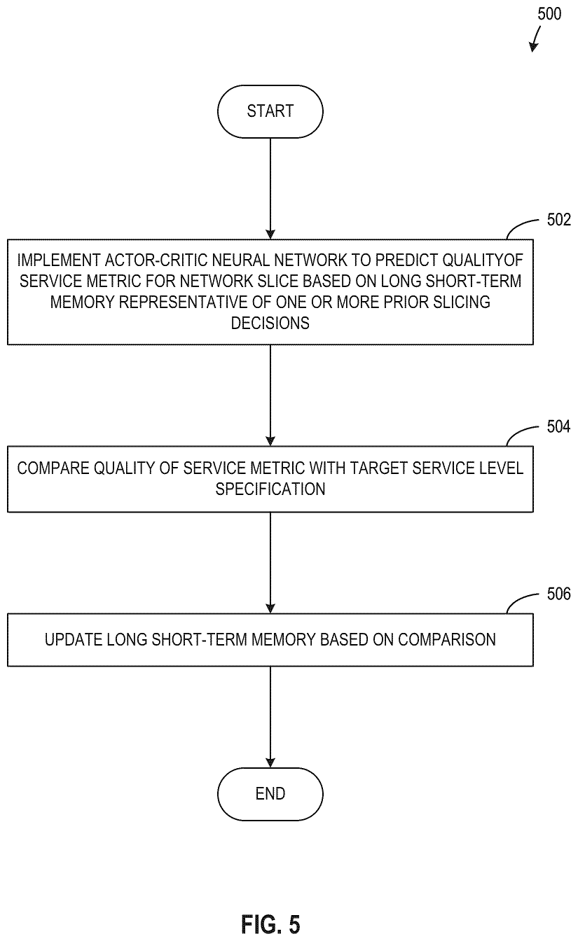

Flowchart(s) representative of example machine readable instructions, which may be executed by programmable circuitry to implement and/or instantiate the network slicing circuitry 110 of FIG. 3 and/or representative of example operations which may be performed by programmable circuitry to implement and/or instantiate the network slicing circuitry 110 of FIG. 3, are shown in FIGS. 5-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-7, many other methods of implementing the example network slicing circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to allocate network resources and compute resources to a network slice using a deep actor-critic recurrent model. The example machine-readable instructions and/or the example operations 500 of FIG. 5 begin at block 502, at which the example network slicing circuitry 110 of FIGS. 1 and 3 implements (e.g., executes, etc.) an actor-critic neural network to predict a quality of service metric for a network slice based on a long short-term memory representative of one or more prior slicing decision. For example, the slicing action circuitry 304 can make a slicing decision associated with the network slice. The example performance prediction circuitry 306 can implement a critic neural network (e.g., RNN) to predict a quality of service metric of the network slice based on prior slicing decisions generated by the slicing action circuitry 304 and embedded in the long short-term memory.

At block 504, the example network slicing circuitry 110 compares the quality of service metric with a target service level specification. In some examples, the target service level specification is associated with a wireless service for which resources have been allocated based on the network slice. Additionally or alternatively, the example network slicing circuitry 110 generates and/or outputs a slicing decision based on a comparison of the quality of service metric with the target service level specification. For example, the slicing action circuitry 304 can output the slicing decision to the example O-DU 154 to schedule users of the network slice.

At block 506, the example network slicing circuitry 110 updates the long short-term memory based on the comparison. For example, the network slicing circuitry 110 (e.g., output evaluation circuitry 308, the policy generation circuitry 310, neural network training circuitry 312, etc.) can embed the slicing decision, the quality of service metric, and a determination of whether the predicted quality of service metric satisfied the target service level specification in the long short-term memory. Thus, the example network slicing circuitry 110 can additionally or alternatively update the long short-term memory of the actor-critic neural network based on the slicing decision.

FIG. 6 is a flowchart representative of example machine readable instructions and/or example operations 600 that may be executed, instantiated, and/or performed by programmable circuitry to allocate network resources and compute resources to a network slice using a deep actor-critic recurrent model. The example machine-readable instructions and/or the example operations 600 of FIG. 6 begin at block 602, at which the example slicing action circuitry 304 executes a first neural network (e.g., FFN) to perform a first slicing action based on observations. In some examples, the observation generation circuitry 302 generates the observations, which indicate the amount of traffic that the network slice computes and/or transmits. At block 604, the example performance prediction circuitry 306 executes a second neural network (e.g., RNN such as an LSTM) to predict a value function based on the observations and the first slicing action. Furthermore, the example performance prediction circuitry 306 determines a cell state of the RNN based on the observation and the first slicing action.

In some examples, slicing action circuitry 304 inputs the observations and previous cell states to the FFN to output a current or updated slicing action that reallocates resources to the network slice to improve the performance of the network slice. In some examples, the performance prediction circuitry 306 inputs the observations, the slicing action, and the previous value function into the RNN to determine a current or updated value function and cell state. The updated value function and cell state can be propagated back to the slicing action circuitry 304 to perform another slicing action and train the FFN. For example, weights of the FFN can be updated, neurons of the FFN can be added, removed, or rearranged, and/or layers of the FFN can be added, removed, or rearranged.

At block 606, the example output evaluation circuitry 308 determines whether the output value function of the RNN satisfies a threshold. In some examples, the threshold corresponds to the SLS of the wireless service associated with the network slice. When the predicted performance of the network slice (e.g., the value function) does not satisfy the SLS, the gradients of the loss function (which depend of value errors) are propagated back to the slicing action circuitry 304 and the example operations 600 proceed to block 608. Furthermore, the observation generation circuitry 302 generates updated observations corresponding to the current network slice.

At block 608, the example slicing action circuitry 304 executes the FFN to perform a second slicing action based on the updated observations and the current cell state. The operations of blocks 604-608 continue in a feedback loop until the predicted value function satisfies the SLS associated with the wireless service. When the example output evaluation circuitry 308 determines that the value function predicted by the performance prediction circuitry 306 satisfies the threshold, then the example operations 600 proceeds to block 610.

At block 610, outputs the current slicing action (e.g., the first slicing action, the second slicing action, etc.) to the network for allocation of resources. Additionally, at block 610, the example policy generation circuitry 310 can output a policy for future slicing actions based on the current slicing action, the current observations, the current cell state, and/or the current value output of the RNN (e.g., the performance prediction circuitry 310). In some examples, the policy is a fixed FFN (e.g., trained FFN) that the slicing action circuitry 304 can execute for one or more wireless services. In some examples, the policy is a mapping from the observations of a wireless service to a probability distribution of the slicing actions for the wireless service. After block 610, the example operations 600 end.

FIG. 7 is a flowchart representative of example machine readable instructions and/or example operations 700 that may be executed, instantiated, and/or performed by programmable circuitry to train an actor-critic neural network model and to slice a cloud network (e.g., O-RAN) using the trained model. The example machine-readable instructions and/or the example operations 700 of FIG. 7 begin at block 702, at which the example observation generation circuitry 302 generates observations for T TTIs. In some examples, the observations are collected at each TTI and averaged to generate the observations. In some examples, the network traffic data is recorded at the end of the T TTIs, and the observations are calculated based on the network traffic data.

At block 704, the example slicing action circuitry 304 slices the network for a wireless service based on previous observations and cell state. In some example, the cell state is determined and/or predicted using the LSTM. At block 706, the example neural network training circuitry 312 determines whether the FFN of the actor-critic model is in a training phase. When the neural network training circuitry 312 determines that the FFN is in the training phase, the example instructions and/or operations 700 proceed to block 708. When the neural network training circuitry 312 determines that the FFN is not in the training phase, the example instructions and/or operations 700 proceed to block 710.

At block 708, the example output evaluation circuitry 308 calculates a loss for the RNN based on the predicted value function of the RNN (e.g., LSTM, etc.). Furthermore, the example output evaluation circuitry 308 performs back propagation through time for the RNN. In some examples, the output evaluation circuitry 308 can provide the loss (e.g., the error) to the slicing action circuitry 304 and/or the neural network training circuitry 312. The example output evaluation circuitry 308 can use the loss to calculate gradients, which are used to update parameters (e.g., train) of the RNN. Additionally or alternatively, the example slicing action circuitry 304 and/or the neural network training circuitry 312 can use the loss to train or update the FNN to improve the slicing action output of the slicing action circuitry 304.

At block 710, the example slicing action circuitry 304 outputs the slicing action to the O-DU 154 for MAC scheduling based on the allocated resources per network slice. That is, the O-DU 154 can control the MAC layer of the network protocol to cause certain user equipment to access the wireless service of the network slice at certain times or with certain prioritizations. After block 710, the example instructions and/or operations 700 end.

FIG. 8 is a block diagram of an example programmable circuitry platform 800 structured to execute and/or instantiate the example machine-readable instructions and/or the example operations of FIGS. 5-7 to implement the network slicing circuitry 110 of FIG. 3. The programmable circuitry platform 800 can be, for example, a server, a workstation, a self-learning machine (e.g., a neural network), an Internet appliance, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example observation generation circuitry 302, the example slicing action circuitry 304, the example performance prediction circuitry 306, the example output evaluation circuitry 308, the example policy generation circuitry 310, the example neural network training circuitry 312, the example neural network processing circuitry 314, and/or, more generally, the example network slicing circuitry 110.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 5-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5-7 to effectively instantiate the circuitry of FIG. 3 as logic circuits to perform operations corresponding to those machine readable instructions. In some such examples, the circuitry of FIG. 3 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 5-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-7. As such, the FPGA circuitry 1000 may be configured and/or structured to effectively instantiate some or all of the operations/functions corresponding to the machine readable instructions of the flowchart(s) of FIGS. 5-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 5-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 5-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 10. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 5-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 5-7, and/or an ASIC may be configured and/or structured to perform third operation(s)/function(s) corresponding to a third portion of the machine readable instructions represented by the flowcharts of FIGS. 5-7.

It should be understood that some or all of the circuitry of FIG. 3 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 3 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

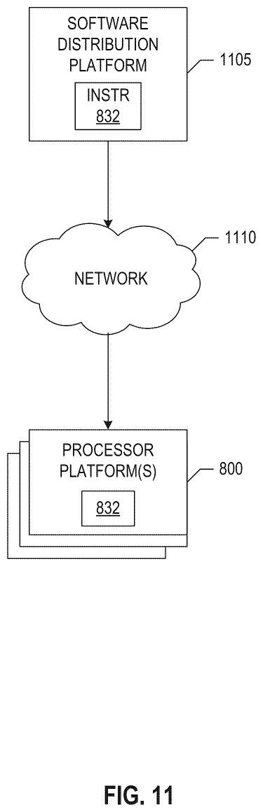

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 5-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 5-7, may be downloaded to the example programmable circuitry platform 800, which is to execute the machine readable instructions 832 to implement the network slicing circuitry 110. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that slice networks for wireless services. Examples disclosed herein introduce example AI-based resource management methods and apparatus for efficient deployment of network slicing at edge datacenters. Disclosed systems, apparatus, articles of manufacture, and methods improve the efficiency of using a computing device by providing an improved RAN AI workload for edge datacenters while enabling customers to achieve efficient and intelligent network management and deployments. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to slice networks for wireless services are disclosed herein. Further examples and combinations thereof include the following:

Example 1 includes an apparatus comprising interface circuitry, instructions, and programmable circuitry to at least one of instantiate or execute the instructions to implement an actor-critic neural network to predict a quality of service metric for a network slice based on a long short-term memory representative of one or more prior slicing decisions, compare the quality of service metric with a target service level specification, and update the long short-term memory based on the comparison.

Example 2 includes the apparatus of example 1, wherein the programmable circuitry is to output a slicing decision for the network slice and a slicing policy for future network slices based on the comparison.

Example 3 includes the apparatus of example 2, wherein the actor-critic neural network includes a first neural network to perform a slicing action based on an observation, the slicing action including allocation of resources associated with a wireless service, the slicing action corresponding to the network slice, and a second neural network to predict a value based on the observation and the slicing action, the value including the quality of service metric associated with the wireless service and the slicing action, and determine a cell state of the second neural network based on the observation and the slicing action, the cell state corresponding to the long short-term memory.

Example 4 includes the apparatus of example 3, wherein the first neural network is a feedforward neural network, and the second neural network is a recurrent neural network.

Example 5 includes the apparatus of example 3, wherein the network slice is a first network slice, the observation is a first observation, and the programmable circuitry is to implement the actor-critic neural network to slice a network into a second network slice based on a second observation and the slicing policy when the quality of service metric does not satisfy the target service level specification of the wireless service.

Example 6 includes the apparatus of example 5, wherein the programmable circuitry is to implement the actor-critic neural network to generate the first observation based on network traffic data corresponding to the wireless service, and generate the second observation based on second network traffic data corresponding to the wireless service and the first network slice.

Example 7 includes the apparatus of example 6, wherein the first network slice is based on a first plurality of observations including (a) a first average number of bits to be processed by the network over a first time period and (b) a first queue length of a radio control link for the wireless service, and the second network slice is based on a second plurality of observations including (a) a second average number of bits to be processed by the first network slice over a second time period and (b) a second queue length of the radio control link for the first network slice.

Example 8 includes the apparatus of example 1, wherein the programmable circuitry is to train an actor of the actor-critic neural network based on a loss between the quality of service metric and the target service level specification.

Example 9 includes the apparatus of example 1, wherein the network slice is associated with an open radio access network.

Example 10 includes the apparatus of example 9, wherein the programmable circuitry is to cause an open radio access network distributed unit to schedule users of a wireless service, the network slice including resources of the wireless service.

Example 11 includes a non-transitory machine readable storage medium comprising instructions to cause programmable circuitry to at least execute an actor-critic neural network to predict a quality of service metric for a network slice based on a long short-term memory representative of one or more prior slicing decisions, generate a slicing decision based on a comparison of the quality of service metric with a target service level specification, and update the long short-term memory based on the comparison.

Example 12 includes the non-transitory machine readable storage medium of example 11, wherein the instructions are to cause the programmable circuitry to output a slicing decision for the network slice and a slicing policy for future network slices based on the comparison.

Example 13 includes the non-transitory machine readable storage medium of example 12, wherein the actor-critic neural network includes a first neural network to perform a slicing action based on an observation, the slicing action including allocation of resources associated with a wireless service, the slicing action corresponding to the network slice, and a second neural network to predict a value based on the observation and the slicing action, the value including the quality of service metric associated with the wireless service and the slicing action, and determine a cell state of the second neural network based on the observation and the slicing action, the cell state corresponding to the long short-term memory.

Example 14 includes the non-transitory machine readable storage medium of example 13, wherein the first neural network is a feedforward neural network, and the second neural network is a recurrent neural network.

Example 15 includes the non-transitory machine readable storage medium of example 13, wherein the network slice is a first network slice, the observation is a first observation, and the programmable circuitry is to implement the actor-critic neural network to slice a network into a second network slice based on a second observation and the slicing policy when the quality of service metric does not satisfy the target service level specification of the wireless service.

Example 16 includes the non-transitory machine readable storage medium of example 15, wherein the instructions are to cause the programmable circuitry to implement the actor-critic neural network to generate the first observation based on network traffic data corresponding to the wireless service, and generate the second observation based on second network traffic data corresponding to the wireless service and the first network slice.

Example 17 includes the non-transitory machine readable storage medium of example 16, wherein the first network slice is based on a first plurality of observations including (a) a first average number of bits to be processed by the network over a first time period and (b) a first queue length of a radio control link for the wireless service, and the second network slice is based on a second plurality of observations including (a) a second average number of bits to be processed by the first network slice over a second time period and (b) a second queue length of the radio control link for the first network slice.

Example 18 includes the non-transitory machine readable storage medium of example 11, wherein the instructions are to cause the programmable circuitry to train an actor of the actor-critic neural network based on a loss between the quality of service metric and the target service level specification.

Example 19 includes the non-transitory machine readable storage medium of example 11, wherein the network slice is associated with an open radio access network.

Example 20 includes the non-transitory machine readable storage medium of example 19, wherein the instructions are to cause the programmable circuitry to cause an open radio access network distributed unit to schedule users of a wireless service, the network slice including resources of the wireless service.

Example 21 includes a method comprising predicting, by executing an instruction with programmable circuitry, a quality of service metric for a network slice based on a long short-term memory of an actor-critic neural network, the long short-term memory representative of one or more prior slicing decisions, outputting, by executing an instruction with the programmable circuitry, a slicing decision based on a comparison of the quality of service metric with a target service level specification, and updating, by executing an instruction with the programmable circuitry, the long short-term memory based on the slicing decision.

Example 22 includes the method of example 21, further including outputting a slicing policy for future network slices based on the comparison.

Example 23 includes the method of example 22, wherein the actor-critic neural network includes a first neural network to perform a slicing action based on an observation, the slicing action including allocation of resources associated with a wireless service, the slicing action corresponding to the network slice, and a second neural network to predict a value based on the observation and the slicing action, the value including the quality of service metric associated with the wireless service and the slicing action, and determine a cell state of the second neural network based on the observation and the slicing action, the cell state corresponding to the long short-term memory.

Example 24 includes the method of example 23, wherein the first neural network is a feedforward neural network, and the second neural network is a recurrent neural network.

Example 25 includes the method of example 23, wherein the network slice is a first network slice, the observation is a first observation, and the programmable circuitry is to implement the actor-critic neural network to slice a network into a second network slice based on a second observation and the slicing policy when the quality of service metric does not satisfy the target service level specification of the wireless service.

Example 26 includes the method of example 25, further including generating the first observation based on network traffic data corresponding to the wireless service, and generating the second observation based on second network traffic data corresponding to the wireless service and the first network slice.

Example 27 includes the method of example 26, wherein the first network slice is based on a first plurality of observations including (a) a first average number of bits to be processed by the network over a first time period and (b) a first queue length of a radio control link for the wireless service, and the second network slice is based on a second plurality of observations including (a) a second average number of bits to be processed by the first network slice over a second time period and (b) a second queue length of the radio control link for the first network slice.

Example 28 includes the method of example 21, further including training an actor of the actor-critic neural network based on a loss between the quality of service metric and the target service level specification.

Example 29 includes the method of example 21, wherein the network slice is associated with an open radio access network.

Example 30 includes the method of example 29, further including causing an open radio access network distributed unit to schedule users of a wireless service, the network slice including resources of the wireless service.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
instructions; and
programmable circuitry to at least one of instantiate or execute the instructions to:
implement an actor-critic neural network to predict a quality of service metric for a network slice based on a long short-term memory representative of one or more prior slicing decisions;
compare the quality of service metric with a target service level specification; and
update the long short-term memory based on the comparison.

2. The apparatus of claim 1, wherein the programmable circuitry outputs a slicing decision for the network slice based on the comparison.

3. The apparatus of claim 1, wherein the programmable circuitry outputs a slicing policy for subsequent network slices based on the comparison.

4. The apparatus of claim 1, wherein the actor-critic neural network includes a first neural network to perform a slicing action based on an observation to generate the network slice, the slicing action to allocate resources associated with a wireless service.

5. The apparatus of claim 4, wherein the actor-critic neural network includes a second neural network to:
determine the quality of service metric based on the observation, the network slice, and the long short-term memory, the quality of service metric associated with the wireless service; and
determine a cell state of the second neural network based on the observation and the network slice, the cell state corresponding to the long short-term memory.

6. The apparatus of claim 5, wherein the first neural network is a feedforward neural network, and the second neural network is a recurrent neural network.

7. The apparatus of claim 6, wherein the network slice is a first network slice, the observation is a first observation, and the programmable circuitry is to implement the actor-critic neural network to slice a network into a second network slice based on a second observation and a slicing policy when the quality of service metric does not satisfy the target service level specification, the target service level specification associated with the wireless service.

8. The apparatus of claim 7, wherein the first observation is included in a first plurality of observations, the second observation is included in a second plurality of observations, and the programmable circuitry is to implement the actor-critic neural network to:
generate the first plurality of observations based on first network traffic data corresponding to the wireless service; and
generate the second plurality of observations based on second network traffic data corresponding to the wireless service and the first network slice.

9. The apparatus of claim 8, wherein the first network slice is based on the first plurality of observations, the second network slice is based on the second plurality of observations, the first plurality of observations include (a) a first average number of bits to be processed by the network over a first time period and (b) a first queue length of a radio control link of the wireless service, and the second plurality of observations include (a) a second average number of bits to be processed by the first network slice over a second time period and (b) a second queue length of the radio control link for the first network slice.

10. The apparatus of claim 1, wherein the programmable circuitry is to cause an open radio access network distributed unit to schedule users of an open radio access network based on the network slice.

11. A non-transitory machine readable storage medium comprising instructions to cause programmable circuitry to at least:
execute an actor-critic neural network to predict a quality of service metric for a network slice based on a long short-term memory representative of one or more prior slicing decisions;
generate a slicing decision for the network slice based on a comparison of the quality of service metric with a target service level specification; and
update the long short-term memory based on the comparison.

12. The non-transitory machine readable storage medium of claim 11, wherein the instructions are to cause the programmable circuitry to output the slicing decision for the network slice based on the comparison.

13. The non-transitory machine readable storage medium of claim 11, wherein the instructions are to cause the programmable circuitry to output a slicing policy for future network slices based on the comparison.

14. The non-transitory machine readable storage medium of claim 11, wherein the actor-critic neural network includes a first neural network to perform a slicing action based on an observation to generate the network slice, the slicing action to allocate resources associated with a wireless service.

15. The non-transitory machine readable storage medium of claim 14, wherein the actor-critic neural network includes a second neural network to:
predict the quality of service metric based on the observation, the network slice, and the long short-term memory, the quality of service metric associated with the wireless service; and
determine a cell state of the second neural network based on the observation and the network slice, the cell state corresponding to the long short-term memory.

16. The non-transitory machine readable storage medium of claim 15, wherein the network slice is a first network slice, the observation is a first observation, and the programmable circuitry is to implement the actor-critic neural network to slice a network into a second network slice based on a second observation and a slicing policy when the quality of service metric does not satisfy the target service level specification, the target service level specification associated with the wireless service.

17. A method comprising:
determining, by executing an instruction with programmable circuitry, a quality of service metric for a network slice based on a long short-term memory of an actor-critic neural network, the long short-term memory representative of one or more prior slicing decisions;
outputting a slicing decision for the network slice based on a comparison of the quality of service metric with a target service level specification; and
updating the long short-term memory based on the slicing decision.

18. The method of claim 17, further including outputting a slicing policy for subsequent network slices based on the comparison.

19. The method of claim 17, wherein the actor-critic neural network includes a first neural network to perform a slicing action based on an observation to generate the network slice, the slicing action to allocate resources associated with a wireless service.

20. The method of claim 19, wherein the actor-critic neural network includes a second neural network to:
predict the quality of service metric based on the observation, the network slice, and the long short-term memory, the quality of service metric associated with the wireless service; and
determine a cell state of the second neural network based on the observation and the network slice, the cell state corresponding to the long short-term memory.
